(19) United States
(12) Patent Application Publication
(10) Pub. No.: US 2005/0030432 A1
(43) Pub. Date: Feb. 10, 2005

(54) Video production switcher with integrated digital video processing

(76) Inventors: David Ross, Nepean (CA); Alun J. Fryer, Nepean (CA)

Correspondence Address: NIXON PEABODY, LLP, 401 9TH STREET, NW, SUITE 900, WASHINGTON, DC, 20004-2128, US

(21) Appl. No.: 10/648,266

(22) Filed: Aug. 27, 2003

Related U.S. Application Data
(63) Continuation of application No. 09/493,182, filed on Jan. 28, 2000, now abandoned.
(60) Provisional application No. 60/117,676, filed on Jan. 28, 1999.

(51) Int. Cl. H04N 5/268; H04N 5/222

(52) U.S. Cl. 348/705; 348/722; 348/584

(57) ABSTRACT

A video production switcher includes at least one multi-level effects generator having at least two keyers and video signal mixer. A digital video processor unit is associated with each of said at least two keyers, the digital video processor operable to generate at least a two-dimensional effect, such as an over-the-should box effect.

### CROSS REFERENCE TO RELATED APPLICATIONS

This application claims the benefit of provisional patent application Ser. No. 60/117,676 filed Jan. 28, 1999, the disclosure of which is incorporated herein by reference.

### BACKGROUND OF THE INVENTION

The present invention is directed to digital video switchers and, more particularly, to an improved digital video switcher having a digital video effects unit integrally incorporated therein and the attendant advantages of such a configuration.

Video mixing typically is accomplished via a mixing system, known in the art as a video switcher. The purpose of a switcher is to mix a plurality of sources of video into a single video signal ultimately to be transmitted or recorded as a single image, either still or dynamic. Known switchers create effects such as wipes, dissolves and keys. For example, a switcher can change scenes by “wiping” from one scene to another, or by dissolving one scene into another directly, or via a neutral, e.g., black, background. Additionally, a switcher can mix the output of a character generator, for example, with a background input, thereby “layering” text on top of the background in accordance with a particular key signal, e.g., a self key, luminance key or a preset pattern key. Known switchers can take virtually any input signal and layer that signal on virtually any background.

Generally, a switcher includes at least one and usually multiple multi-level effects (MLE) amplifiers or mixers, each capable of mixing two or more video inputs to create a single video output signal. If it is desired to produce a composite image that includes more signals than a single MLE can accommodate, then the output of one MLE can be fed into the input of a second downstream MLE where further layering can be accomplished. This process can continue until all available MLEs on the switcher are consumed, whereby a highly complicated video image can be devised.

With the advent of digital electronics, video switchers have been developed that act on digitized video signals whereby editing capabilities have been improved. Additionally, it has become commonplace to incorporate into video images digital effects which, due to advanced digital processing, have become more complex and elaborate. Specifically, many switchers, in addition to being capable of receiving inputs from multiple video sources, now also often are connected to, and receive inputs from an external digital video effects (DVE) unit. These DVEs typically have exceptional capabilities including two-dimensional compression and three-dimensional transformation of video images, as well as the ability to position a digitally altered video signal anywhere in a background signal, when matched with an appropriate key signal.

In prior art video production, DVEs are external devices connected to a video switcher via an auxiliary bus (or busses), which is not part of the internal architecture of the switching loop of the switcher. That is, in prior art DVE implementations, the DVE is supplied with video sources outside of the switcher and the output thereof is fed back to the switcher, specifically an MLE of the switcher, via an auxiliary bus. If a key also is supplied by the DVE, then that key is supplied to the keyer of the appropriate MLE, also via a separate auxiliary bus.

While this architecture for implementing DVE functionality is operative, it also tends to be more complex and, importantly, more difficult to set up and operate to achieve the desired effect. For example, as noted, a separate auxiliary bus is necessary to exploit the functionality of a DVE. Thus, multiple additional cables, jacks, and connectors are required to set up the proper connections between the video switcher and external DVE. Also, separate programming of the switcher is necessary to recognize and properly communicate with the external DVE. Moreover, in operation, a switcher operator must initiate the use of the external DVE by depressing buttons to access the auxiliary bus and properly route the desired video signal through the DVE and back into the switcher. In modern, fast-paced, real time video production, however, these additional set up requirements and elaborate operator control are highly undesirable.

Furthermore, there is a general disincentive to combine DVEs with switchers due to the resulting prohibitive cost and relatively short effective usefulness particularly in view of the rapid advancement of the effects that can be generated by DVEs, and thus the desire to upgrade.

Additionally, control of a DVE in the prior art typically resides with the DVE itself, not with a control panel of a switcher. Accordingly, DVE implemented effects must be set up in the DVE beforehand, as it is difficult to reprogram a DVE and control a switcher at the same time. This again hampers a switcher operator from fast-paced video editing since only effects previously arranged or programmed can be implemented.

Furthermore, manufacturers of video switchers and DVEs have heretofore often been different. While this market reality has led to perhaps greater advances in the respective technologies, switcher owners have been forced to purchase DVEs with ever more advanced capabilities even though an operator might want only to execute relatively simple DVE generated effects. Similarly, switcher operators often are forced to use an advanced external DVE, or at least a channel thereof, to implement relatively simple DVE-generated effects. Thus, not only are precious auxiliary bus resources being consumed, but the DVE itself, though highly capable, is being used for a relatively simple effect. This type of operation is neither economical nor efficient.

### BRIEF SUMMARY OF THE INVENTION

The present invention overcomes the problems noted above, and provides additional advantages, by providing a video production switcher incorporating therein a digital video effects unit (DVE). A video production switcher in accordance with an exemplary embodiment of the invention includes at least one muti-level effects generator (MLE) having at least two keyers and a video signal mixer. A digital video processor unit (DVP) is associated with each of said at least two keyer, where said DVP is operable to generate at least a two-dimensional OTS box effect. Because the DVP generates relatively limited effects only, both the hardware and software associated with the DVP is highly simplified and therefore much less expensive to develop and to manufacture. Also, the DVP is much smaller physically and thus consumes much less “real estate” in the switcher circuitry. This smaller size and focused functionality also reduces the power consumption of this part thereby reducing the power consumption of the overall switcher, while still providing an effect that was possible previously only via a much physically larger and higher power consuming machine. As a result, the cost of having an OTS box effect available is significantly reduced.

### BRIEF DESCRIPTION OF THE DRAWINGS

The present invention can be understood more completely by reading the following Detailed Description of the Preferred Embodiments, in conjunction with the accompanying drawings, in which:

FIG. 1 is a general schematic diagram of a video switcher in accordance with the present invention;

FIG. 2 is a detailed schematic diagram of region 10 of FIG. 1

FIGS. 3-34 are schematic diagrams depicting preferable electronic circuitry for achieving the functionality described herein. Specifically, FIGS. 3-18 are board level schematics that depict preferable circuitry for achieving the functions of the present invention. FIGS. 19-34 are further schematics that depict preferable functionality provided by one or more field programmable gate array (FPGA) such as that shown in the lower half of FIG. 4, or any other suitable integrated circuit, chip or other memory device.

### DETAILED DESCRIPTION OF THE PREFERRED EMBODIMENTS

Integrated DVP Architecture

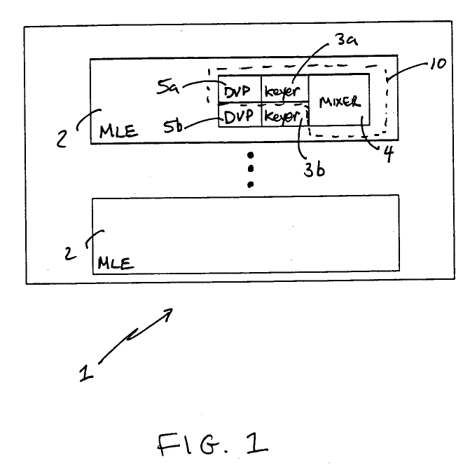

The preferred embodiments of the present invention will now be described with reference to the Figures. FIG. 1 depicts schematically and very generally a video switcher 1 having at least one multi-level effects (MLE) generator 2 having two keyers 3a, 3b and a video signal mixer 4. In accordance with the present invention, each keyer 3a, 3b is also associated with a digital video processor unit (DVP) 5a, 5b, which are reduced-functionality digital video effects units (DVEs). For simplicity, the following discussion will be limited to the explanation of a single MLE and its corresponding keyers and DVPs. However, it will be understood by those of skill in the art that the following discussion is equally applicable to any number of cascaded or stand alone MLEs in a video switcher.

As noted earlier, DVEs typically are external devices that have complex capabilities. Typical external DVEs can perform image compression, expansion, rotation and other two and three-dimensional transformation effects such as “page turning” and mosaic effects. Also, these DVEs typically are very expensive due to their advanced capabilities. However, the effects available via an external DVE often go to waste in that only relatively simple effects generally are called for in the majority of video production situations. For example, the present applicants discovered that one effect that is in demand most frequently is an over-the-shoulder box effect. This is a two-dimensional effect that places a video image within a box, which can be bordered, and, via an MLE, layers the generated image over a background scene. This effect is most often desired in news casting where an over-the-shoulder (OTS) box is placed beside a newscaster's shoulder and video corresponding to the story being reported is shown in the box.

In accordance with a preferred embodiment of the present invention, therefore, each DVP 5a, 5b etc. preferably is capable of generating at least a two-dimensional OTS box effect, but three-dimensional effects also are possible with a DVP in accordance with the present invention. For simplicity, the discussion with respect to DVPs 5a and 5b will focus on DVP 5a only, but it is understood that the functionality and interconnectivity thereof (to be described in detail) is applicable to any number of additional DVPs. As shown in FIG. 1, and in more detailed figures to be discussed later herein, the DVP 5a is integrally incorporated into the switching loop of the MLE 2. Accordingly, DVP 5a has a number of advantages over conventional high-powered DVEs. First, because DVP 5a preferably generates relatively limited effects only, both the hardware and software associated with the DVP is highly simplified and therefore much less expensive to develop and to manufacture. DVP 5a is therefore much smaller physically and thus consumes much less “real estate” in the switcher circuitry. This smaller size and focused functionality also reduces the power consumption of this part thereby reducing the power consumption of the overall switcher 1, while still providing an effect that was possible previously only via a much physically larger and higher power consuming machine. As a result, the cost of having an OTS box effect available is significantly reduced.

In the preferred embodiment of the present invention DVP 5a is a separate module, e.g. a piggyback printed circuit board (PCB), that easily can be connected or disconnected from a main PCB that includes a mixer 4 and keyers 3a, 3b associated with an MLE. This construction permits the DVP to be an option for consumers who may not necessarily find it desirable to have the capabilities made possible by the present invention. Moreover, by having the DVP be a separate module the hardware and/or software associated therewith easily can be modified or upgraded as necessary.

Two DVPs and Keyers in Each MLE

As shown generally in FIG. 1, each MLE 2 preferably has associated with it two keyers 3a, 3b and each keyer 3a, 3b has associated therewith one DVP 5a, 5b, respectively. In other words, each MLE in accordance with the present invention has at least two dedicated DVPs and two dedicated keyers. Thus, in accordance with the present invention, each MLE 2, on its own, has the ability to layer on top of a background two additional video signals, whereby three separate images can be incorporated together in a single scene. More importantly, each MLE 2 can layer two keyed signals that have first been processed by the integrally-incorporated DVP, without having to access an auxiliary bus or use the resources of an external DVE. As will be explained in more detail later herein, the internal DVP 5a is arranged in the switching loop of the MLE 2 before the keyer 3a. Accordingly, not only does the internal DVP provoke a digital video effect with respect to an input video source, but the thus generated video effect is subsequently routed to a keyer wherein a key signal, also known as an alpha signal by those skilled in the art, is generated, which key signal tracks the digitally-altered video signal precisely. This architecture, in accordance with the present invention, provides highly desirable functionality as will be discussed below.

In a preferred embodiment of the present invention, DVP 5a generates one or multiple two-dimensional effects only, which generally are easier and thus less expensive to implement, whereby incorporation into a switcher becomes economical.

Programming of Preset Pattern as OTS Box when Fly Key Button is Pushed

Since an OTS box is a digital video effect often most desired in video production, the video switcher of the present invention provides a simplified and efficient system for invoking such functionality. Prior art video switchers have key enabling areas on control panels that permit an operator to invoke a particular type of key. For example, an operator can depress a button on a control panel that causes a keyer in an MLE to apply a self key to a designated video input. The MLE subsequently mixes, i.e, layers, on a background image a key video signal image in accordance with the output of the keyer. Typically, controls are provided for selecting various keys such a self key, chroma key or preset pattern key.

In accordance with the present invention, an additional control is provided on the switcher control panel, namely a “fly key” button. The fly key button, when depressed, as will be described in even more detail below, causes the DVP 5a of MLE 2 to be inserted in the switching loop of the switcher 1 before the keyer 3a. That is, in a preferred embodiment of the present invention, when the fly key button is depressed, the video signal from which the desired key will be generated will first be routed through, or “flown,” through the DVP 5a wherein the video signal preferably is compressed and positioned in accordance with a desired size and location of the OTS box. Again, the DVP 5a preferably is preprogrammed to generate an OTS box only and, as such, when the fly key button is depressed the DVP 5a is automatically inserted in the switching loop and automatically create an OTS box and further automatically generates a desired compressed video image from which a key signal is subsequently generated.

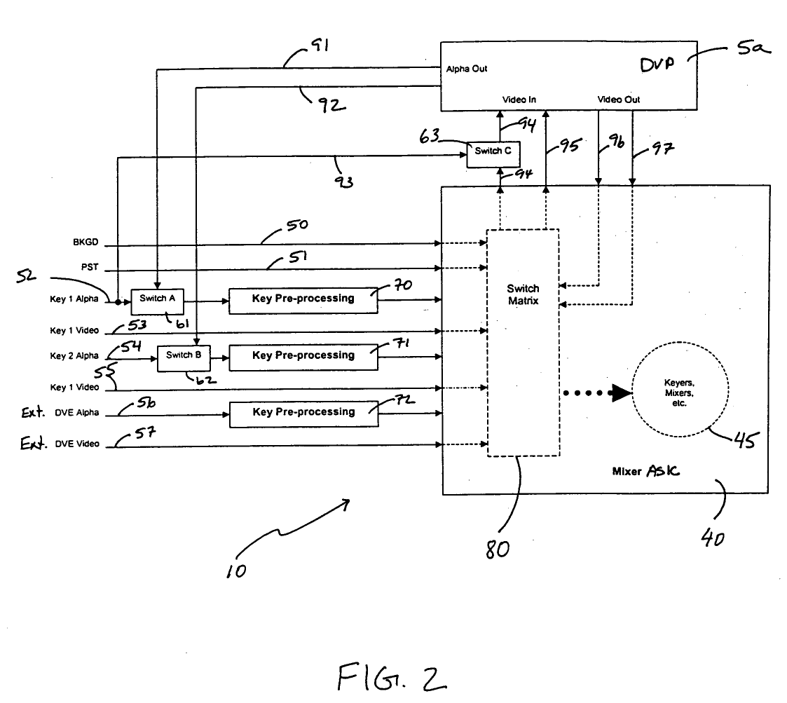

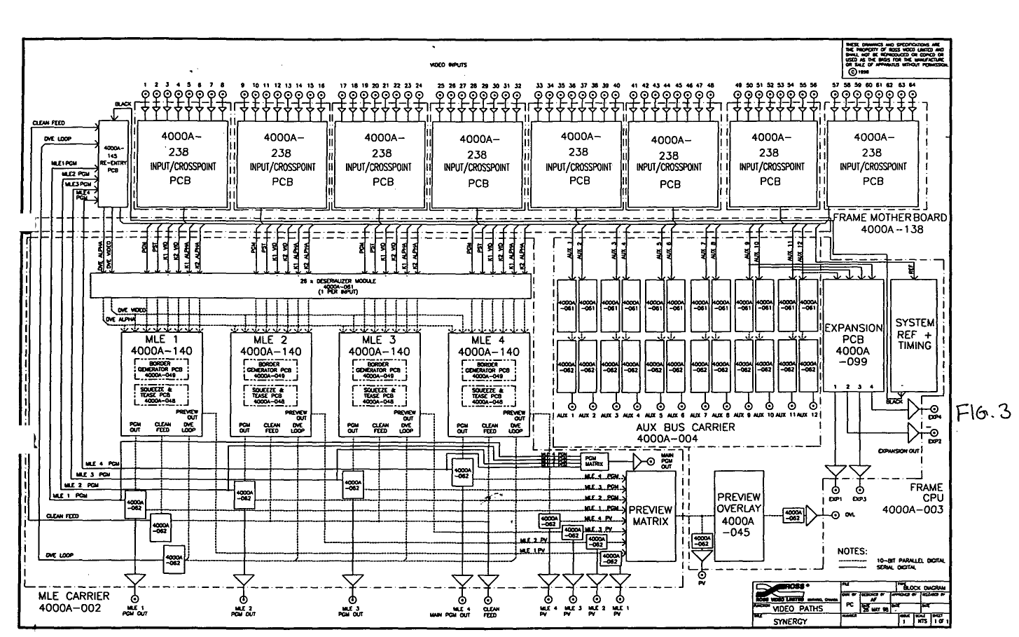

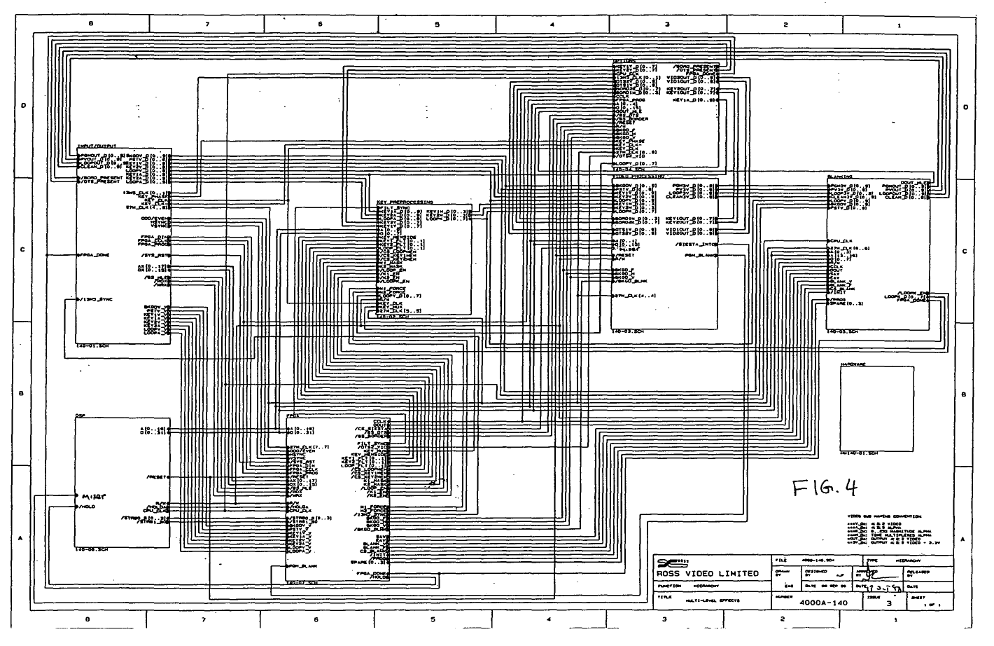

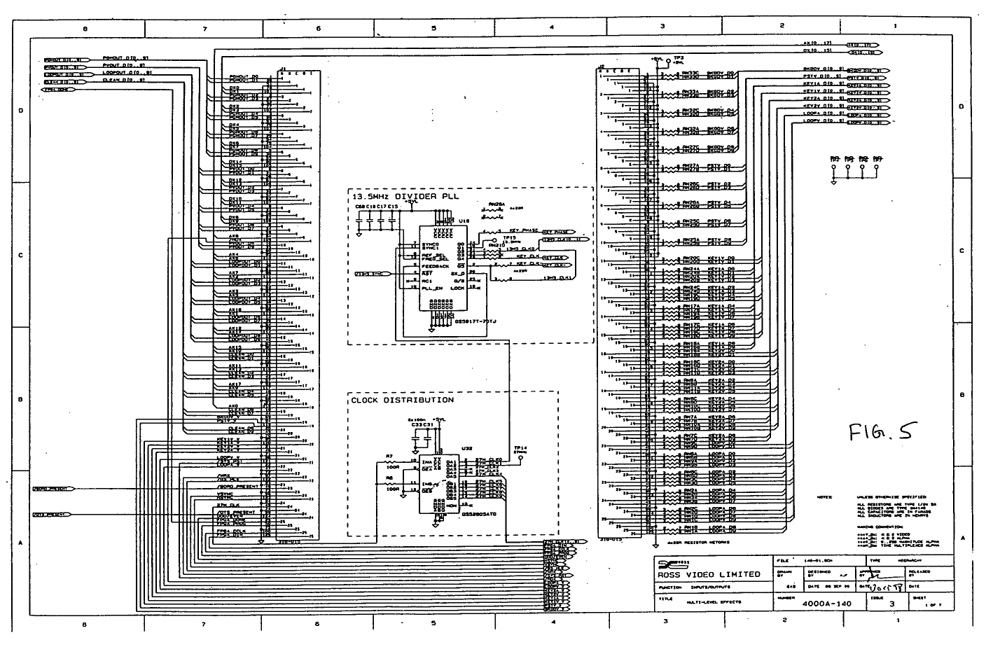

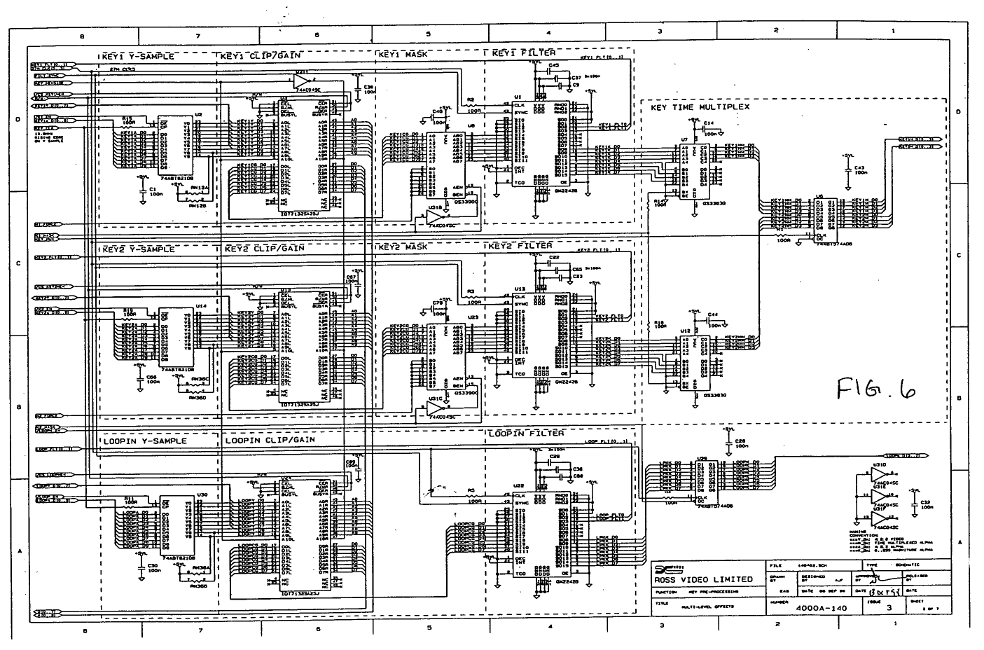

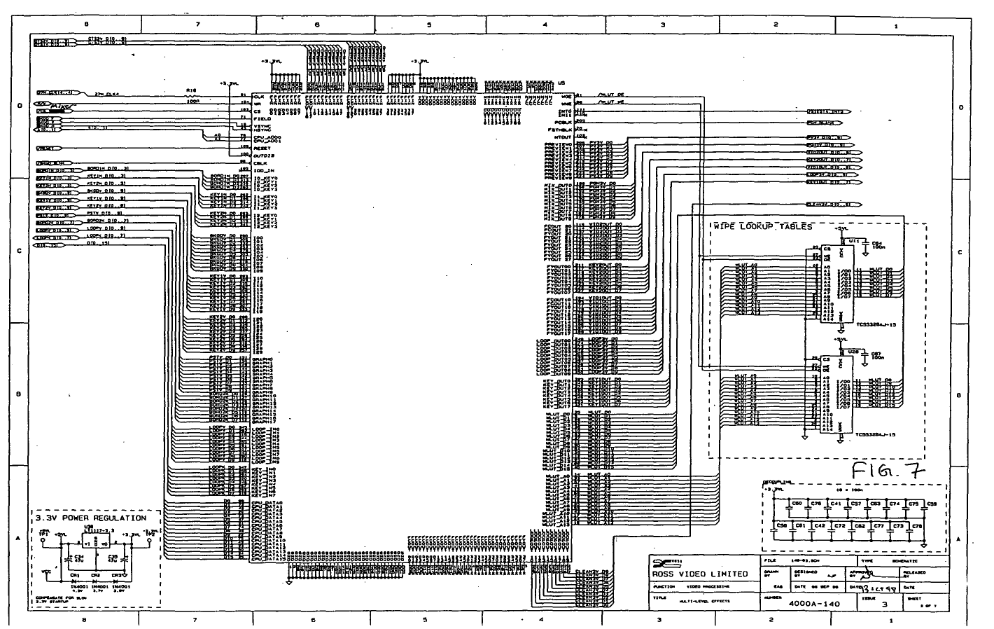

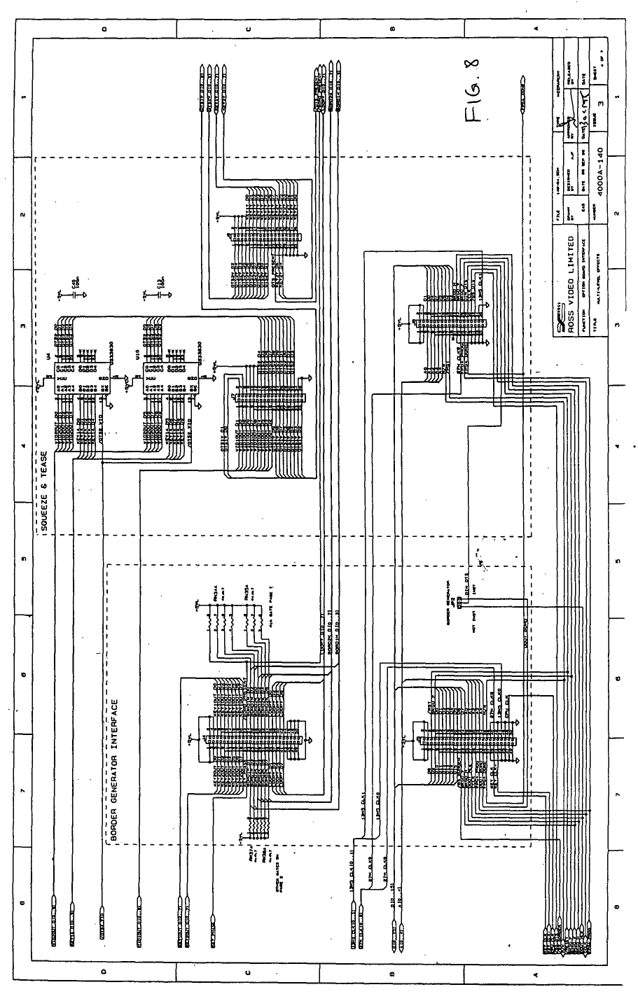

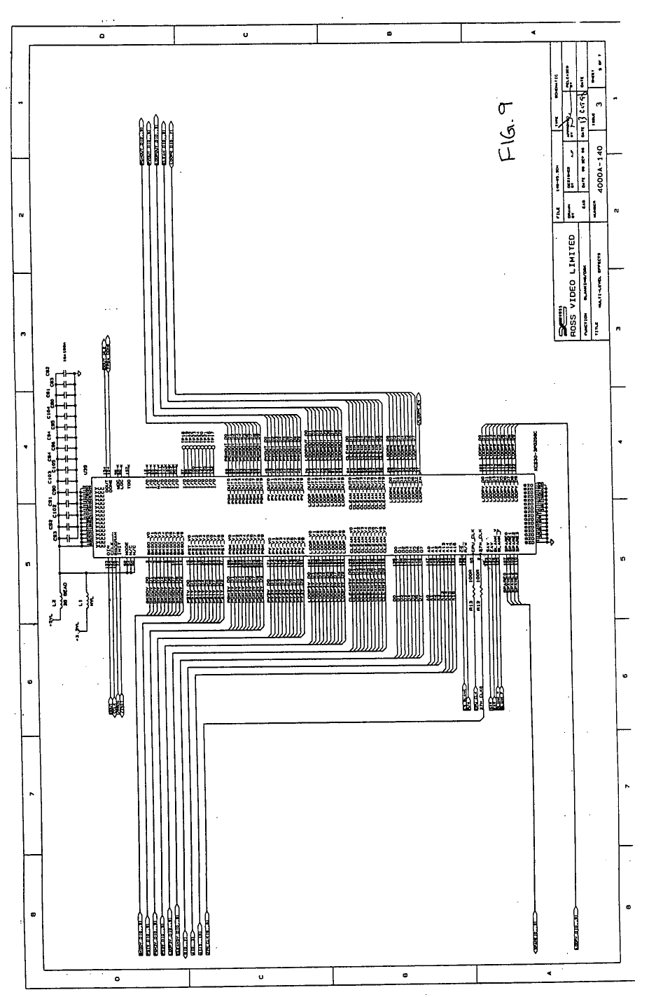

Referring now to FIG. 2 which is a detailed depiction of region 10 of FIG. 1, there is shown a module 40 that is comprised of discrete components or, preferably is provided in a portion of an application specific integrated circuit (ASIC) that preferably also is programmable. Module 40 includes at least one keyer such as keyer 3a and a downstream digital mixer 45, both of which are well known in the art. Also incorporated into module 40 is a switch matrix 80 that performs routing operations necessary to insert DVP 5a in the switching loop of MLE 2.

Specifically, a background 50, preset 51, key 1 alpha 52, key 1 video 53, key 2 alpha 54, key 2 video 55, external DVE alpha 56 and external DVE video 57 are all provided as inputs, either directly or indirectly to switch matrix 80. Each of key 1 alpha, key 2 alpha and external DVE alpha is passed through key processing circuits 70, 71, 72, respectively, before reaching switch matrix 80. Key processing circuits 70, 71, 72 perform shaping and translation, as necessary, to raw mixer control signals. Additionally, key masking and filtering preferably is performed in this stage. These functions are known in the art.

In addition, region 10 of MLE 2 includes switch A 61, switch B 62 and switch C 63 that operate to switch DVP 5a into the MLE's switching loop. DVP 5a includes key alpha outputs 91 and 92, video inputs 94 and 95 and video outputs 96 and 97.

Preferably, there are two configurations in which the DVP 5a is used. The first configuration is where the two channels of the DVP 5a work independently. In this mode each channel of DVP 5a is used to fly a video image. In this case switch C 63 is set to pass the output of the switch matrix 80 to DVP 5a. This mode is used for flying a chroma key, self key, or preset pattern-type, e.g., box, key. It is possible to key these images since no external key alpha is required. Specifically, with a self key, the key alpha is generated by processing the squeezed, or compressed, video's brightness. With a chroma key, the key alpha is generated by processing the squeezed, or compressed, video's color information. And, with the preset pattern key, the key alpha is generated by the DVP 5a itself, as it is already preprogrammed to generate a box. The alpha signal generated by the DVP 5a is routed via signal path 91 or 92 back into switch matrix 80 via Switch A 61 or Switch B 62, and an external alpha signal is not used. Alternatively, if so equipped, the alpha signal preferably is generated by module 40 by an internal pattern generator embedded therein.

The second configuration is where both channels of DVP 5a work together to fly a single auto-select key. An auto-select key is one where the video image and the key do not necessarily correspond exactly one with the other, as is the case with a self key, for example. With an auto-select key, there necessarily is the need both for separately provided key video and alpha signals. Thus, in this mode one channel, e.g. input 94, is used to fly the key video, and the other channel, e.g. 95, is used to fly the key alpha. Switch C 63 is set to pass the key 1 alpha 52 to DVP 5a. The compressed video is passed back to module 40 via video output 96, 97 and the alpha is passed back to module 40 through switch A 61 or switch B 62 via the appropriate key pre-processing circuit.

Significantly, in both configurations in accordance with the present invention, the video is keyed after manipulation of the images by DVP 5a. When DVP 5a is not active for a particular key, each of switches 61, 62 is set to pass the external key alpha directly to switch matrix 80.

The above-described functionality is particularly useful for reasons previously stated. Particularly, when a key type is selected, that key type can then be flown through a DVP of an MLE by first routing the key video through the DVP thereby not only applying digital effects to the video signal, but also thereby obtaining a key signal that is consistent or properly associated with the digitally altered video since the keyer for the MLE is downstream from the DVP. This combination is then mixed in the usual manner in the associated MLE. That is, the switcher in accordance with the present invention permits an operator to add an OTS box that has compressed video therein. External DVE access is unnecessary thereby saving both auxiliary bus and external DVE resources for other digital video effects. And, from an operator point of view, the set up and execution of an OTS box effect is simplified whereby efficient control of the video production is achieved.

Flying a Key Through DVP Activates Associated Joystick

In addition to the automatic selection and implementation of an OTS box by DVP 5a, the switcher of the present invention provides manipulation of control parameters of DVP 5a via a three-dimensional joystick on the operator control panel. The three-dimensional joystick becomes active and automatically is associated with a DVP on any MLE once the fly key button in the associated MLE has been enabled. The three-dimensional joystick controls the placement in the background of the of the OTS box in vertical and horizontal directions. A third dimension of the joystick controls the size of the OTS box that is generated by DVP 5a. Specifically, via the joystick it is possible to control the amount of compression or expansion that is applied to the key video that is to be inside the OTS box. Again, the joystick automatically becomes active upon activation of the fly key feature of the present invention. And, the joystick is thus immediately available to the switcher operator for manipulation in real time. Thus, in accordance with the present invention, no complicated remote control of an external DVE is necessary since the DVP 5a, i.e. the limited-function DVE, is integrally incorporated into an MLE. Control thereof is thus simplified.

Feedback of DVP Effect Provided on Control Panel

Further in accordance with the present invention, the control panel of the switcher 1 preferably includes a LCD screen or the like that provides a variety of menus for switcher set up and operational functions. Among the operational functions provided is feedback regarding the vertical and horizontal position and size of the OTS box generated by DVP 5a. This information preferably is graphically depicted on the LCD such that an operator can see immediately whether the OTS box, if generated, would be generated off of the viewable area of a television screen or within that viewable area. Specifically, the LCD screen depicts a square or rectangular outline that represents the viewable area of a television screen. Then, when an OTS box is generated via the DVP 5a, the location and size of the generated OTS box also is shown, preferably in outline form, on the same LCD screen whereby the relative location of the OTS box with respect to a viewable area can easily be seen. Such functionality provides a switcher operator the tools desired to perform error-free switching operations in an efficient manner.

Preset Pattern Positioned on Top of OTS Box to Give Appearance of a “Box” of Any Shape

In another preferred embodiment of the present invention, while the DVP 5a preferably is limited to two-dimensional digital effects, and more preferably to generating an OTS box, any such generated OTS box can be manipulated in such a way as to appear to be any one of a plurality of shapes. That is, the DVP 5a can generate an OTS box which feeds the background of a keyer which is used to superimpose a preset pattern of any known shape over the OTS box. Such shapes can be circular, diamond-like, or any other shape that is among the many preset patterns known in the art. Accordingly, the “box” of the OTS box need not necessarily be square, i.e. be restricted to the shape of the OTS box that is generated by the DVP 5a.

DVE Send Maintains Access to External DVE via Aux Bus and Provides Capability of Sending “Pre-Combined Transitioning Video” with DVE Send Button

The switcher 1 of the present invention includes a further unique feature known as “DVE Send.” DVE Send allows an operator to control an external DVE's effect timeline with a fader bar or transition lever, exactly as if it were an internal switcher effect. That is, instead of effecting a scene via a conventional wipe or dissolve implemented with a transition lever, the DVE Send feature can be invoked whereby selected portions of the layered image resident at that time in the MLE 2 are routed to the external DVE where they can be digitally altered thereby producing a digital video transition effect such as a “page turn.” Significantly, the effect is controlled seamlessly from the transition lever, just like a wipe effect.

The DVE Send feature is made possible in the present invention by incorporating in MLE 2 a third keyer (not shown) that is activated only by invocation of the DVE Send feature. In a preferred embodiment, the third keyer is dormant when DVE Send is not being used. DVE Send is implemented as follows. In the “next transition” area of the switcher control panel, typically located adjacent a fader bar (not shown), in addition to the well-known buttons for effecting transitions among any combination of background, key 1 and key 2, there is also provided a button for enabling DVE Send. When depressed, the switcher 1 automatically routes the desired signals, e.g. background and key 1, to an external DVE via the auxiliary bus and returns the digitally altered video signal back to the switcher 1, and particularly, back to the third keyer within the MLE from which the transition was initiated.

By having a third keyer resident in an MLE and available at all times to an external DVE, it is possible to send to an external DVE “pre-combined transitioning video,” whereby the MLE can act further on the return signal from the external DVE. Importantly, the architecture of the switcher according to the present invention makes it possible to send a “partially composited” image to an external DVE, and the image sent need not necessarily be the output of an MLE. Indeed, the architecture of the present invention permits a user to access an external DVE and incorporate its output directly in the transitioning functionality of a single MLE. Prior art switchers require the use of two MLEs to perform the same function.

Moreover, the switcher in accordance with the present invention still provides conventional connection to external DVEs like that expected in prior art devices. However, the present switcher incorporates one and preferably multiple DVPs that perform relatively less complicated digital video effects thereby saving any external DVE for more elaborate effects.

Software

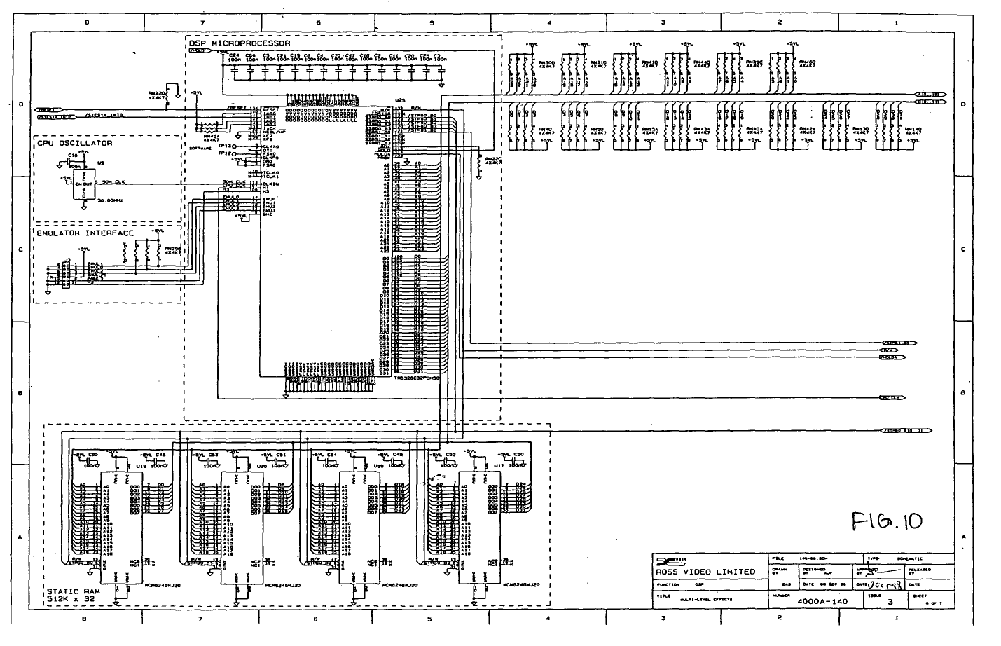

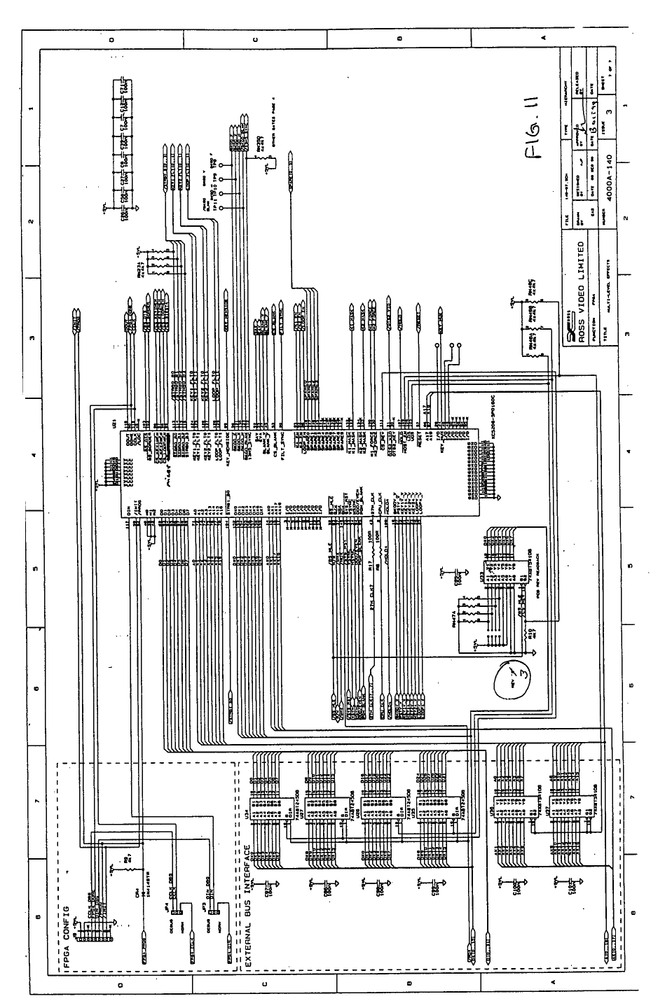

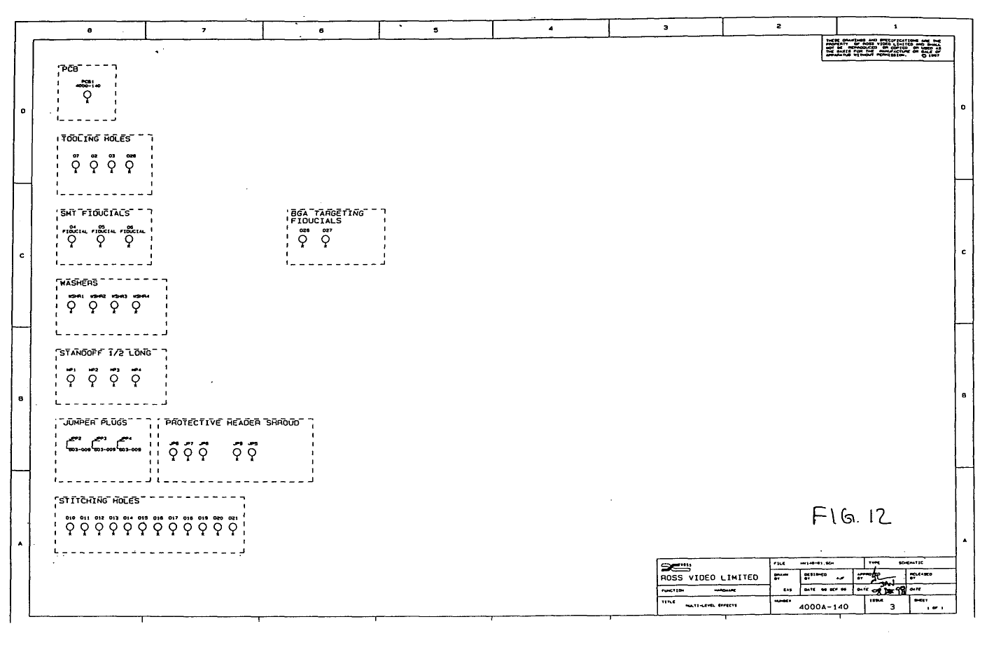

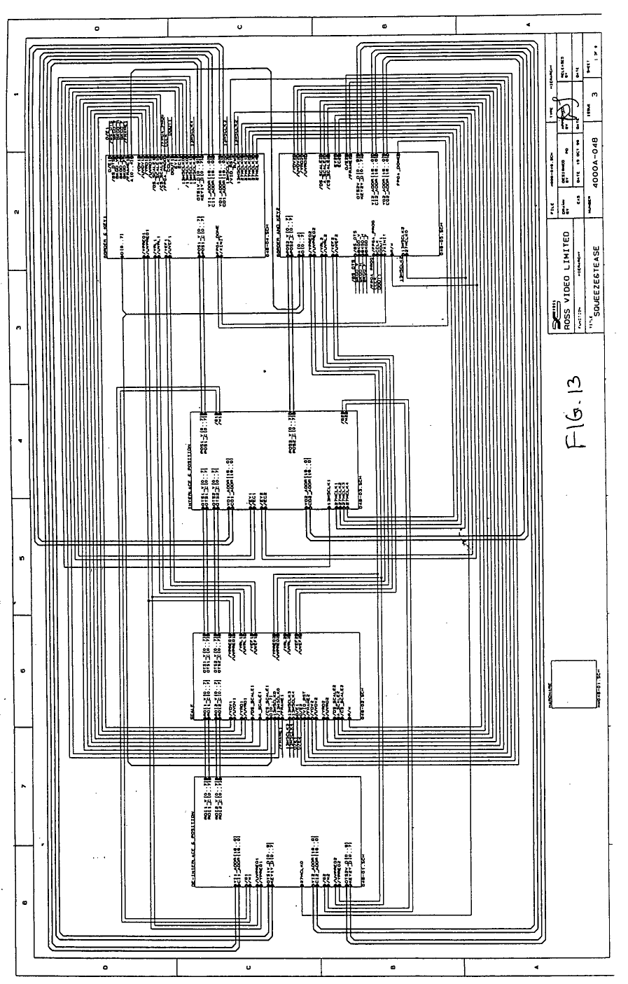

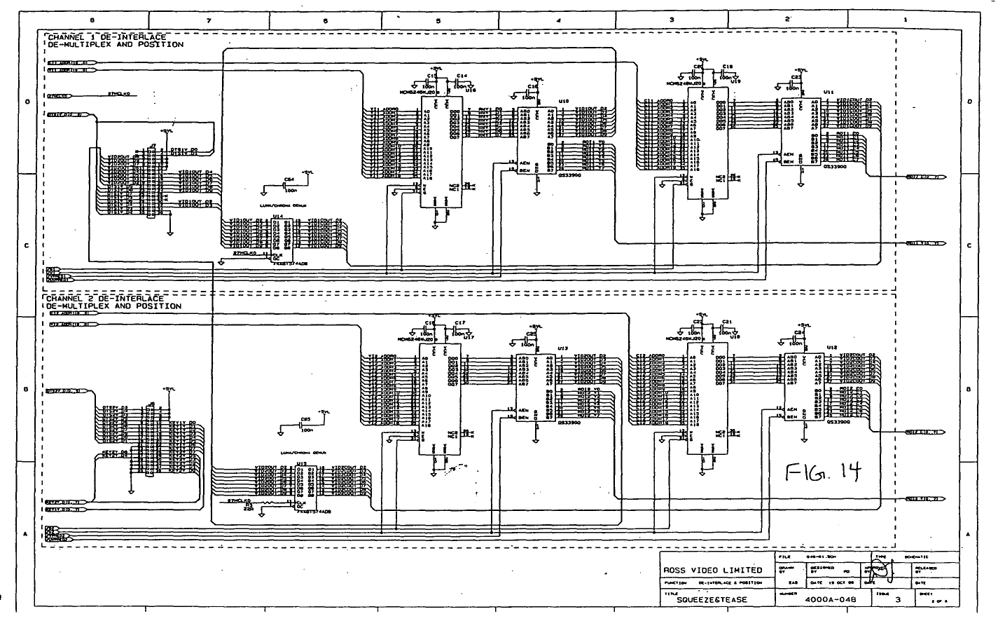

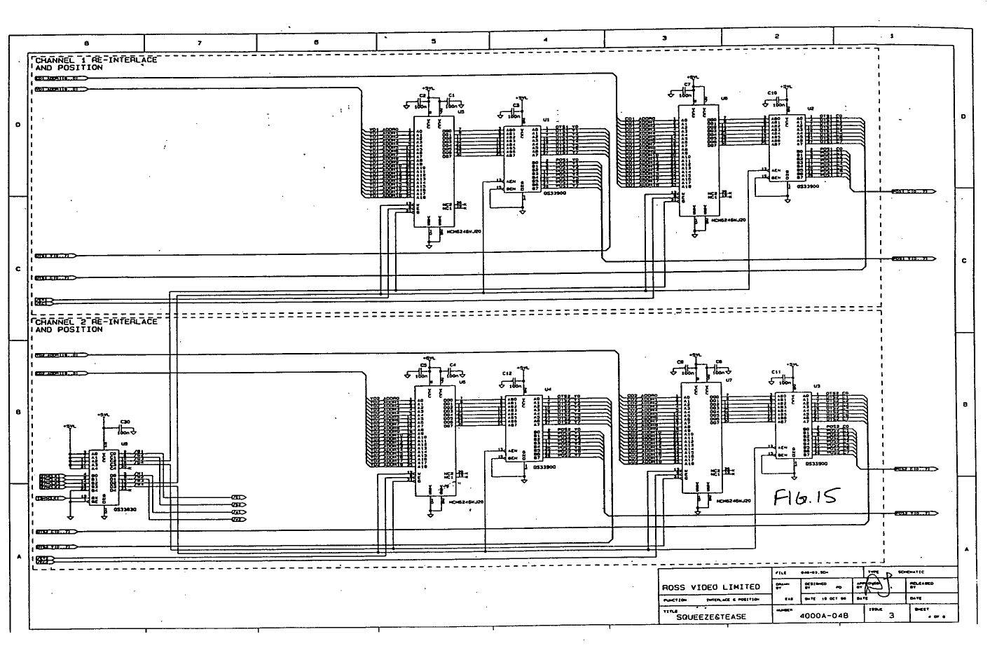

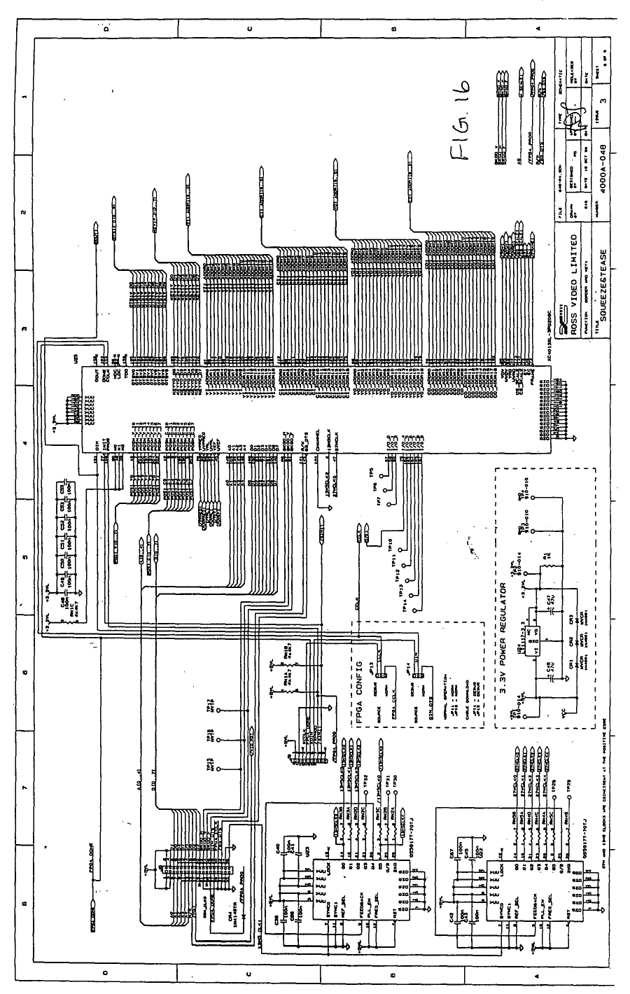

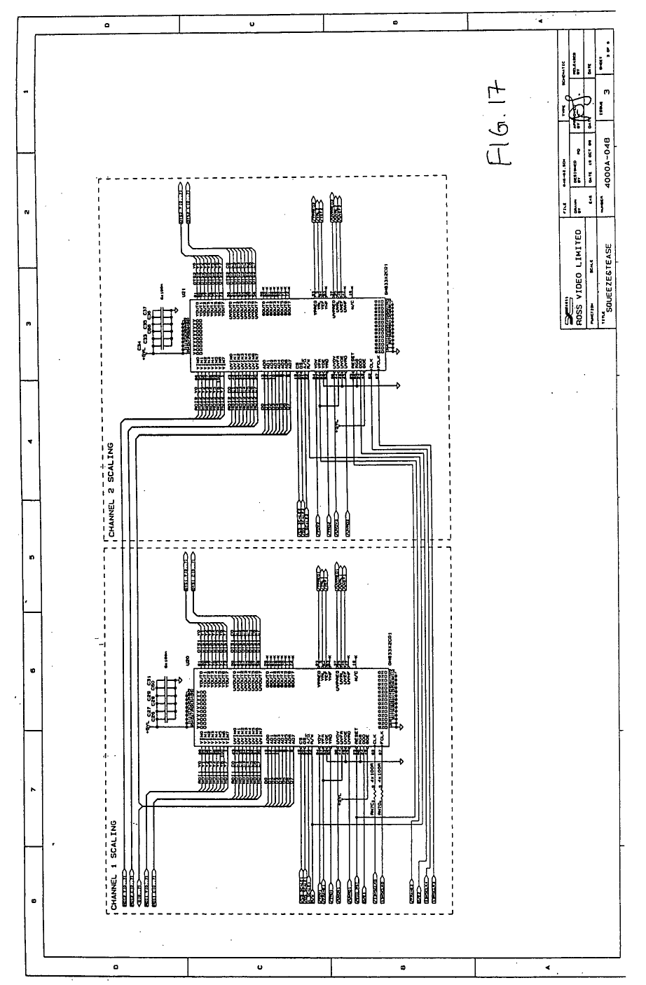

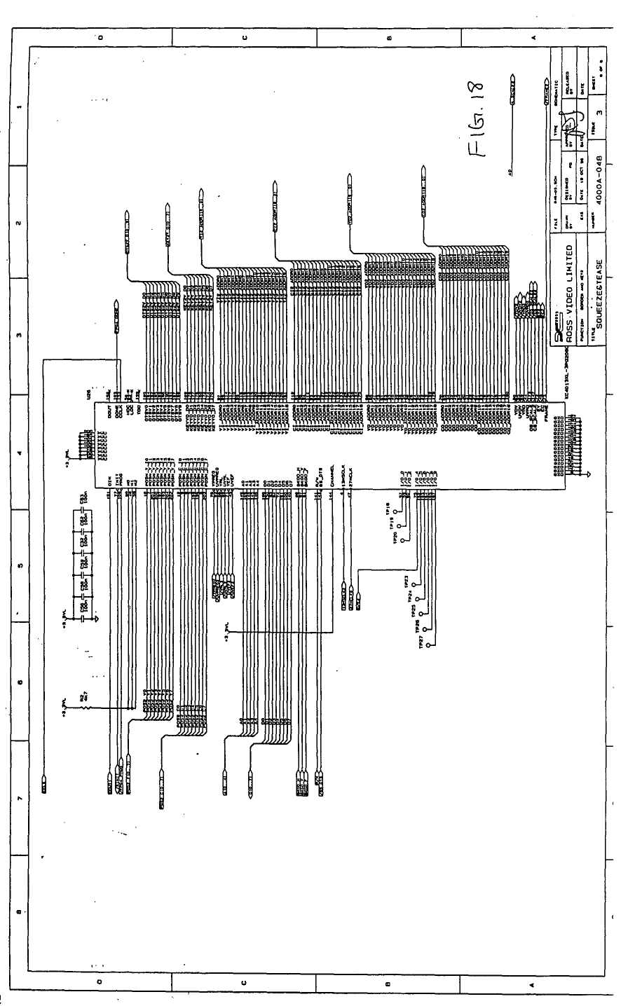

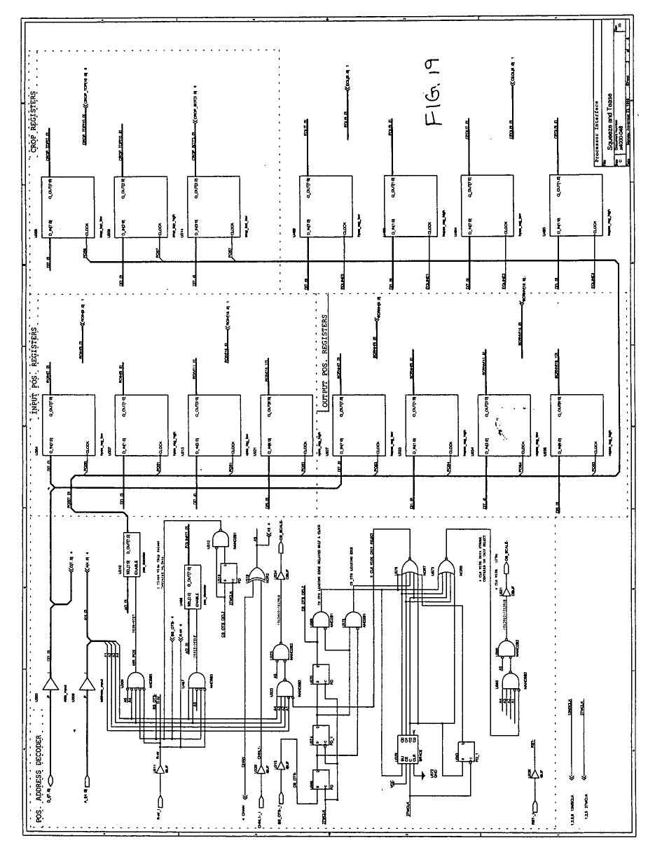

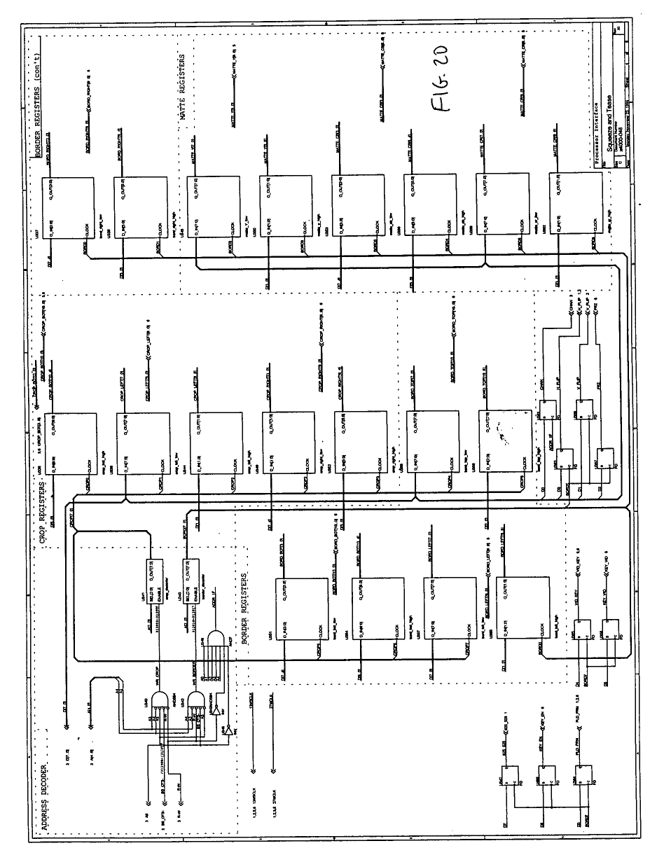

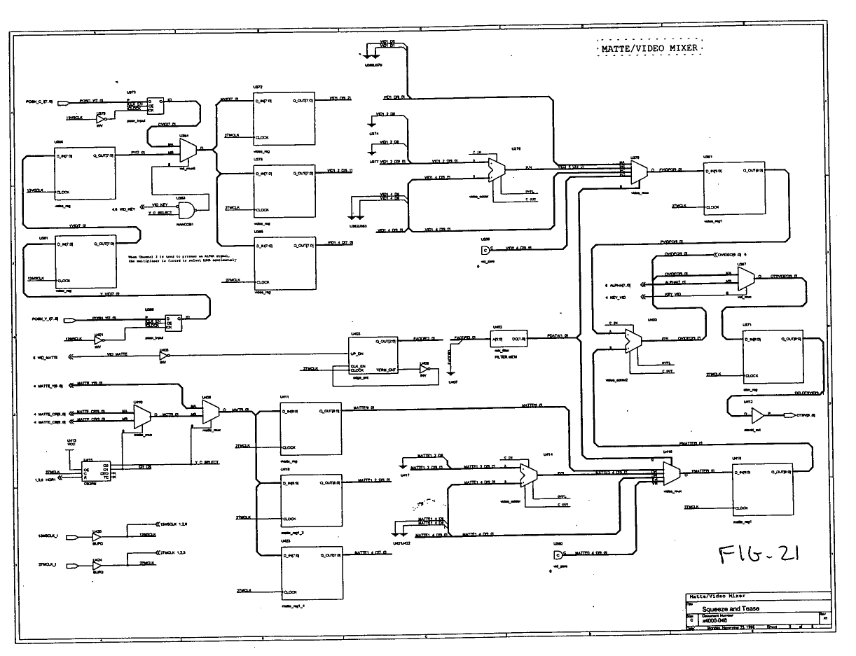

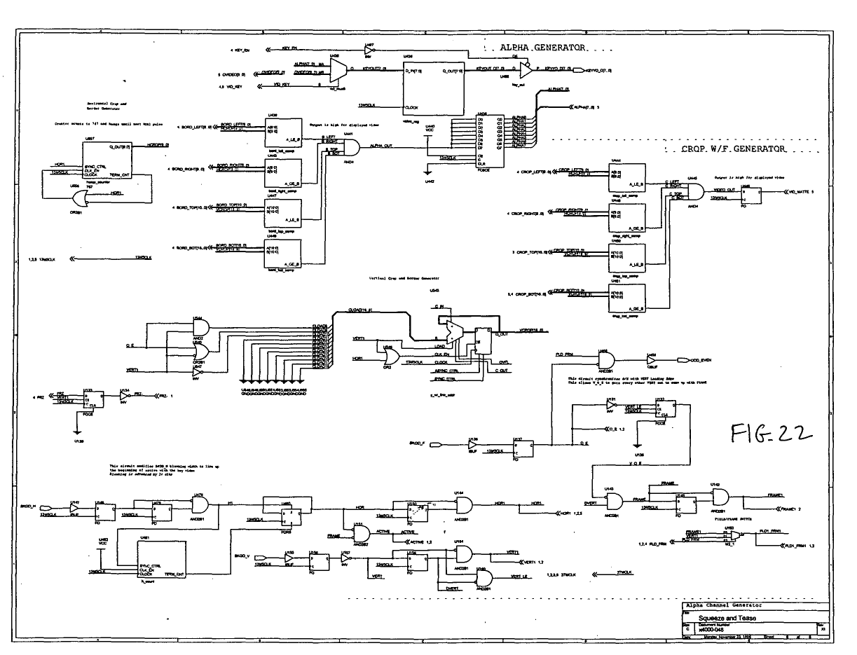

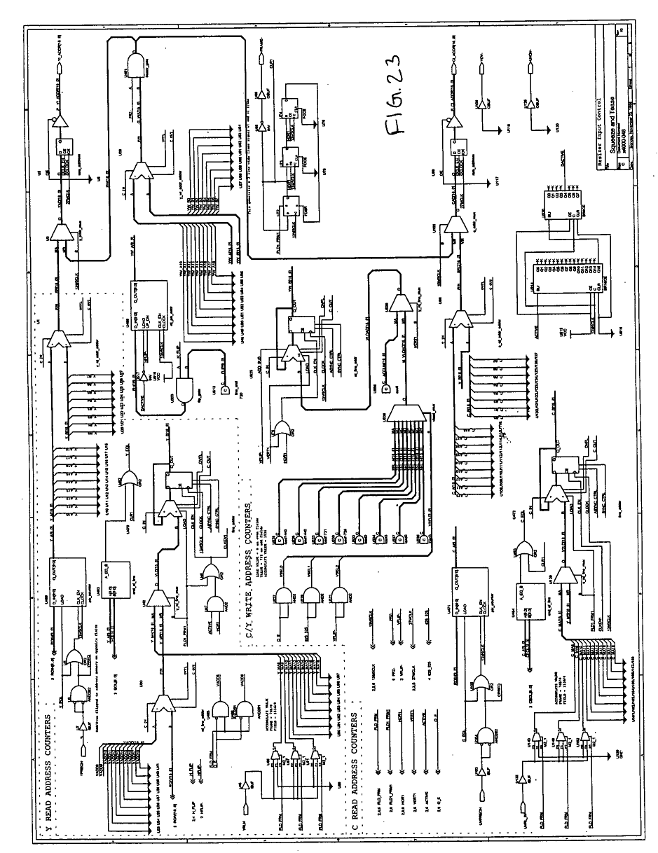

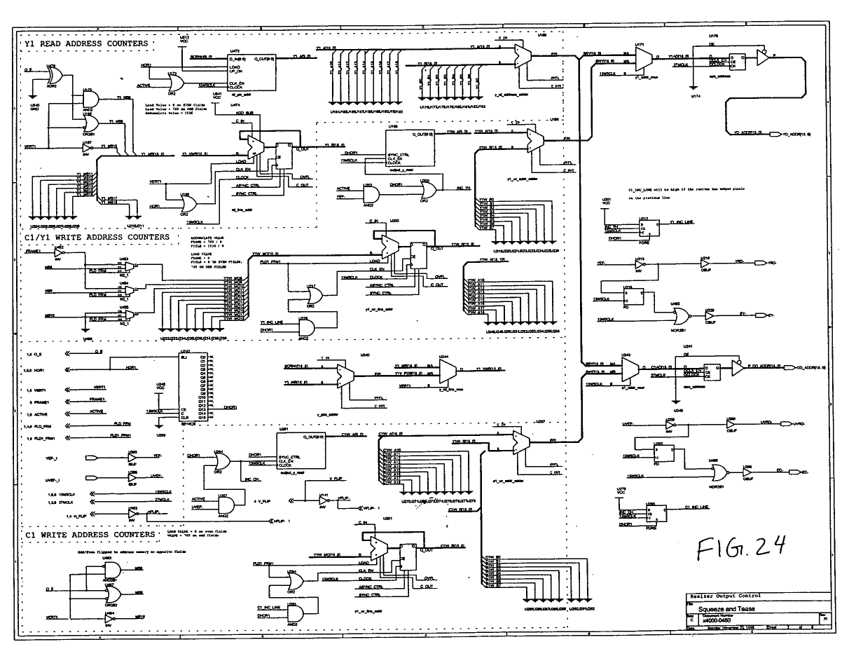

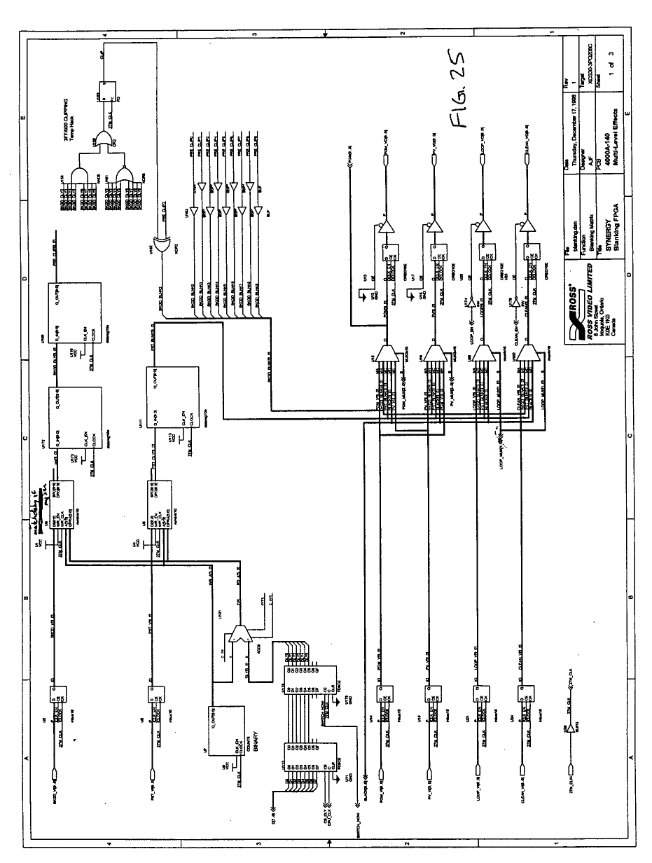

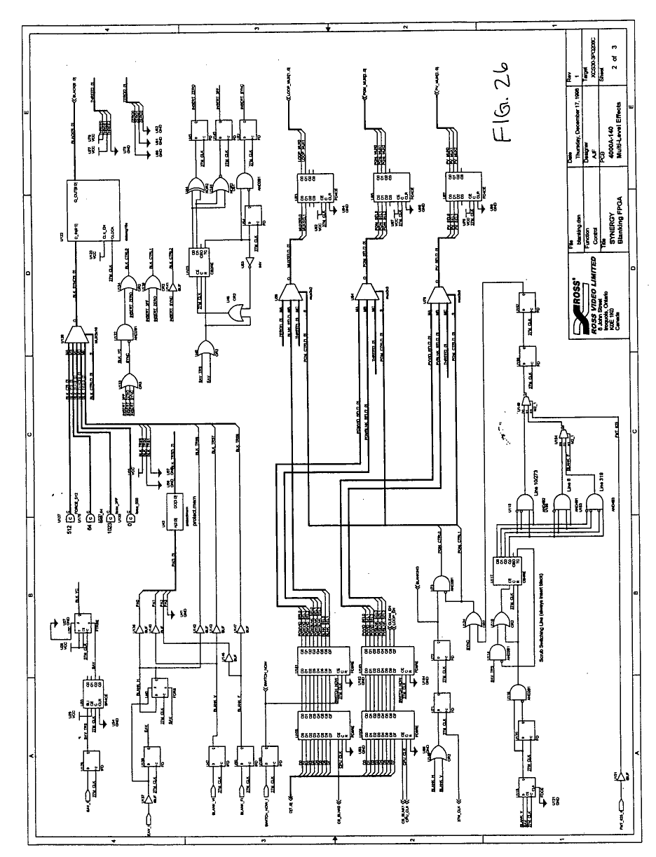

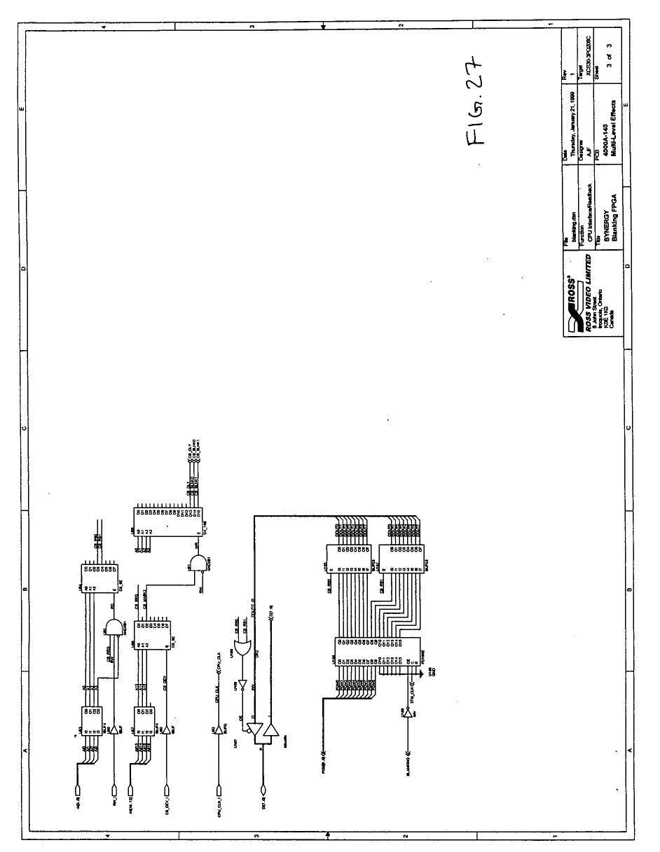

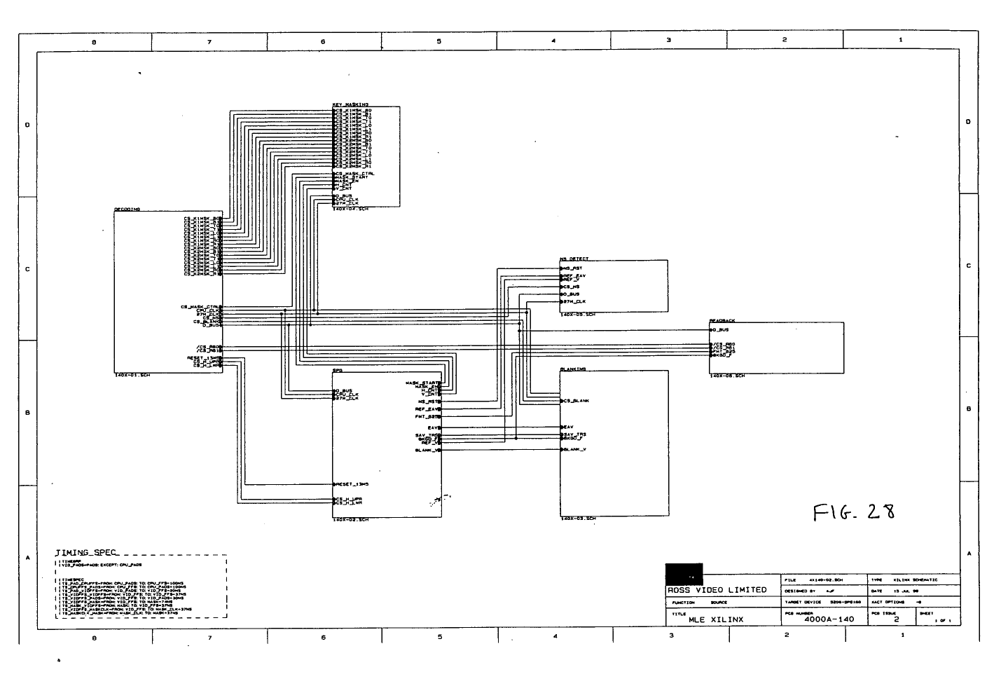

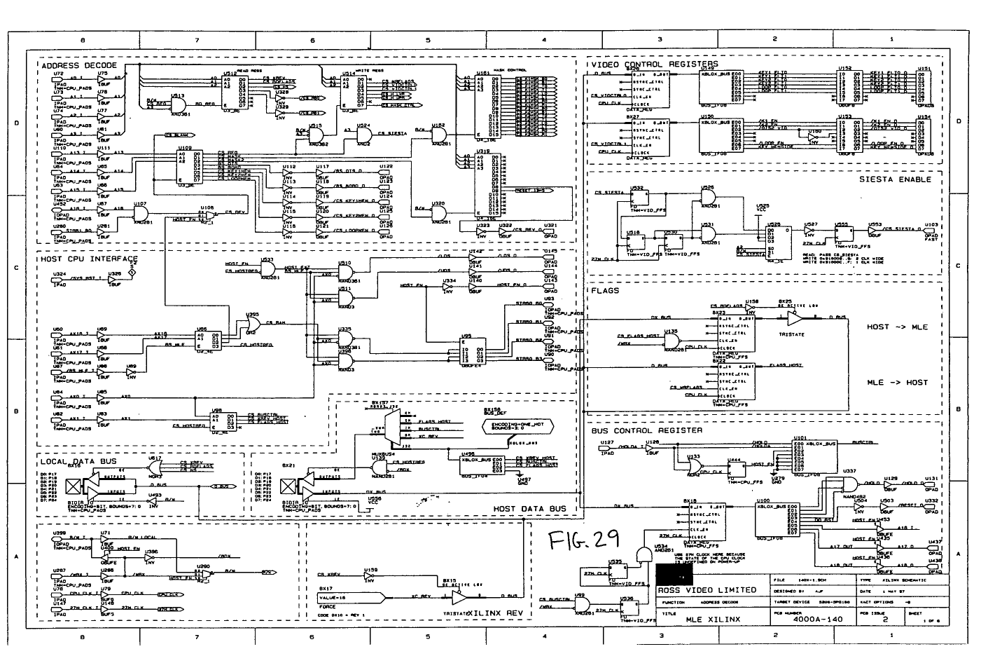

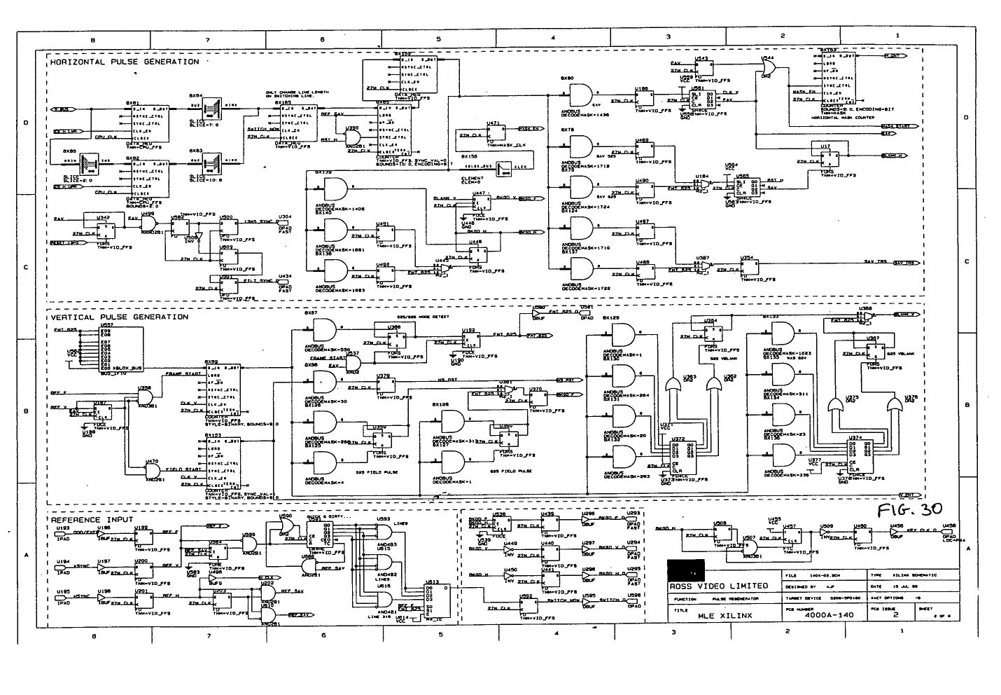

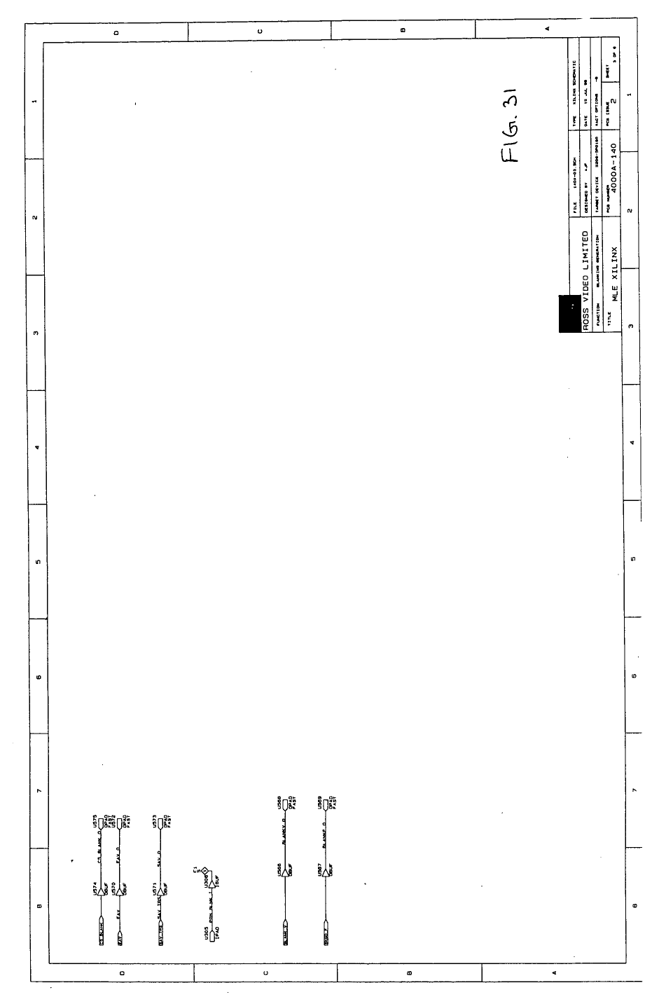

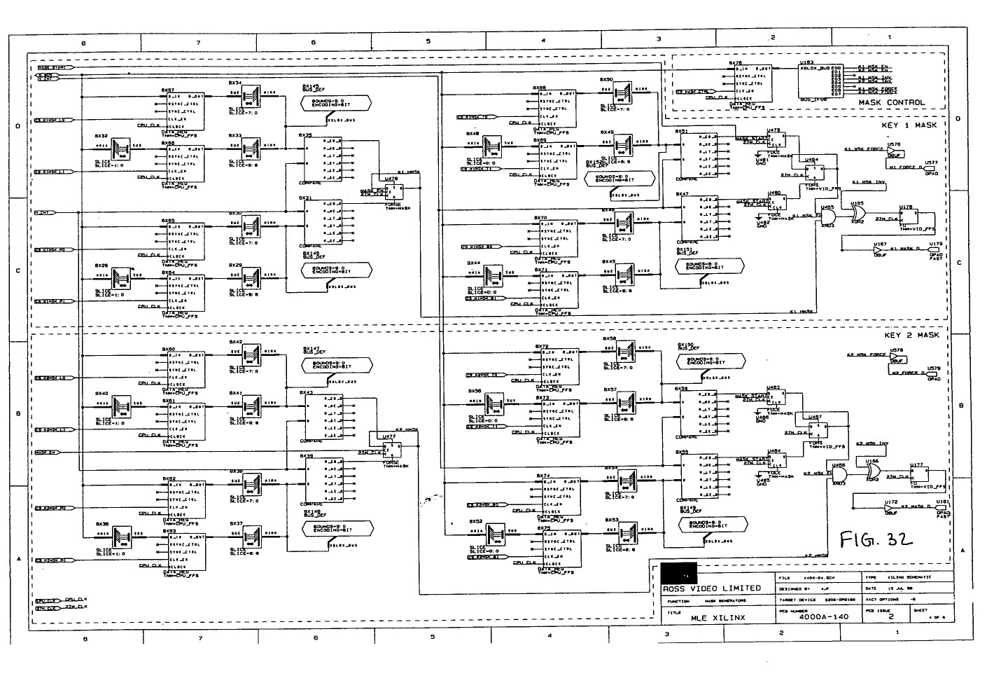

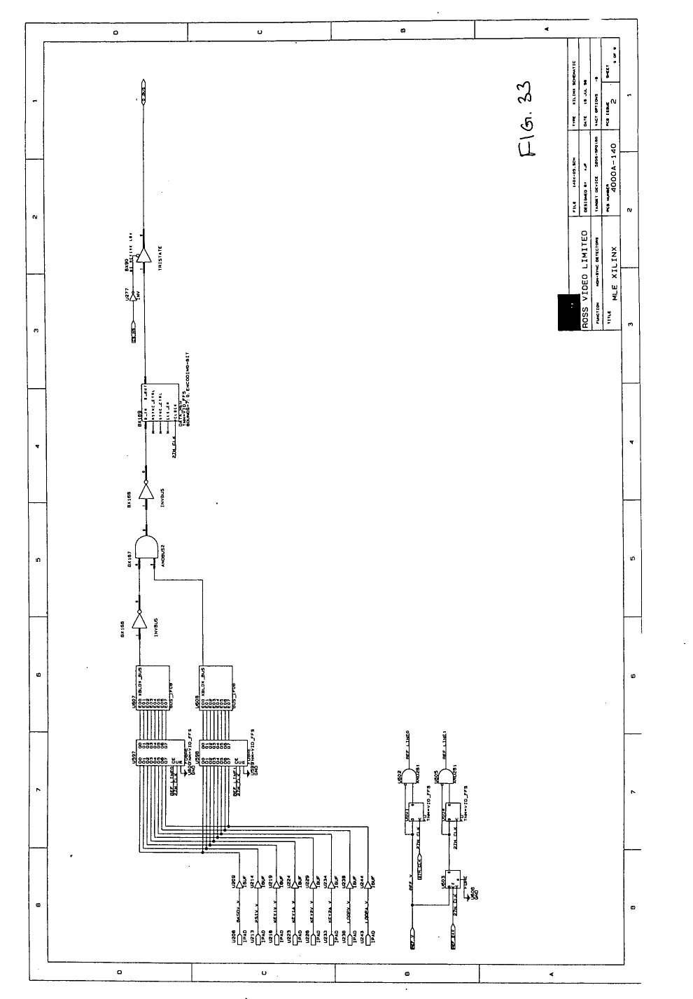

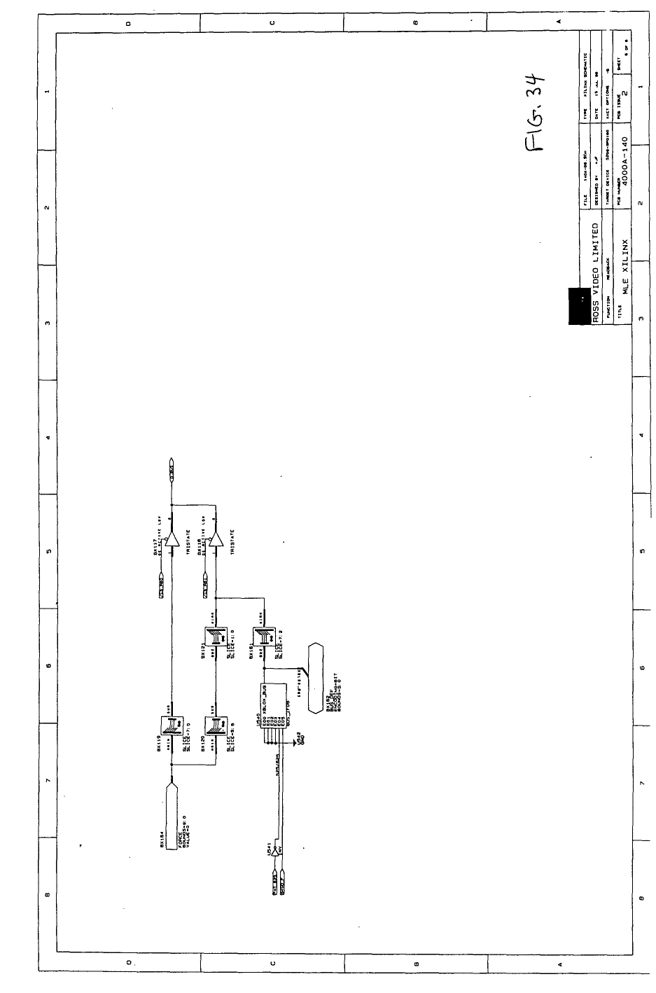

In addition to the electronic circuitry depicted, appendices A-G set forth preferred software that, in the preferred embodiment, is run by at least one microprocessor, such as that shown in FIG. 10.

1. A video production switcher comprising:
a main circuit board,
at least one multi-level effects generator having at least two keyers and a video signal mixer,
at least two digital video processing units integrally connected with said main circuit board and electrically connected to said at least two keyers, respectively, wherein each of said digital video processor units is operable to generate at least a two-dimensional video effect.

2. The switcher of claim 1, further comprising a digital video effects send that allows a selected portion of a layered image to be routed to an external digital video effects unit for editing.

3. The switcher of claim 1, wherein the video signal mixer is capable of being cascaded.

4. The switcher of claim 1, wherein the at least one multi-level effects generator is capable of being cascaded.

5. A video switcher comprising:
a main circuit board,
at least one multi-level effects generator having at least two keyers and a video signal mixer,
at least two digital video processing units integrally connected with said main circuit board and electrically connected to said at least two keyers, respectively, wherein each of said digital video processor units is operable to generate at least a two-dimensional video effect
a switcher control panel, the switcher control panel allowing a video signal from which a desired key will be generated to be first routed through a respective of the digital video processing units.

6. The switcher of claim 5, wherein the video signal is compressed.

7. The switcher of claim 5, wherein the video signal is positioned at a specified location with a specified size.

8. The switcher of claim 5, wherein the control panel further comprising comprises a display that displays information about one or more of operational functions and switcher configuration.

9. The switcher of claim 8, wherein a horizontal position, a vertical position and a size of an over the shoulder box are displayed.

10. The switcher of claim 1, comprising:
at least two of said multi-level effects generators, wherein intermediate signals generated by the multi-level effects generators can be accessed.

11. The switcher of claim 5, comprising:
at least two of said multi-level effects generators, wherein intermediate signals generated by the multi-level effects generators can be accessed.
